(19) United States
(12) Patent Application Publication
(10) Pub. No.: US 2026/0113293 A1
(43) Pub. Date: Apr. 23, 2026

(54) EFFICIENT EMAIL ACCOUNT SYNCHRONIZATION MANAGEMENT

(71) Applicant: Notions Labs, Inc., San Francisco, CA (US)

(72) Inventors: Byeong Chan Lee, Long Island City, NY (US); Peter Lu, San Francisco, CA (US); Arpeet Kale, San Jose, CA (US); Ryan Kuang, Pasadena, CA (US)

(21) Appl. No.: 19/081,935

(22) Filed: Mar. 17, 2025

Related U.S. Application Data
(60) Provisional application No. 63/708,638, filed on Oct. 17, 2024.

(51) Int. Cl. H04L 51/42

(52) U.S. Cl. CPC H04L 51/42

(57) ABSTRACT

The present disclosure provides systems and methods for synchronizing email accounts across different email clients. Permission is obtained from a user to access a first email account and a second email account, where the first and second email accounts are accessible via different email clients. Existing emails are uploaded from the second email account to the first email account and indications of changes in resources associated with the email accounts are received and replicated across accounts to maintain synchronization. Additionally, API usage is managed by determining an API quota count and pending API usage count and queueing the replication of changes between email accounts until API quota limits will not be exceeded. Furthermore, search queries received when the accounts are not synchronized are translated into a format compatible with an API of the second email client. The second email client is queried and a response to the translated search query is received and displayed.

### CROSS-REFERENCE TO RELATED APPLICATION(S)

This application claims priority to and the benefits of U.S. Provisional Application No. 63/708,638, titled “EMAIL SYSTEM SYNCING TO A THIRD-PARTY CLIENT” filed on Oct. 17, 2024. The content of the aforementioned application is herein incorporated by reference in its entirety.

### BACKGROUND

Electronic mail, or email, is a method of transmitting and receiving messages using electronic devices. Email is a ubiquitous and very widely used communication medium often treated as a basic and necessary part of many processes in business, commerce, government, education, entertainment, and other spheres of daily life in most countries. Email operates across computer networks, primarily the Internet, and also local area networks. Today's email systems are based on a store-and-forward model. Email servers accept, forward, deliver, and store messages. Neither the users nor their computers are required to be online simultaneously; they need to connect, typically to a mail server or a webmail interface, to send, receive, or download messages.

An application programming interface (API) is a connection between computers or between computer programs. It is a type of software interface, offering a service to other pieces of software and connecting software entities together. Email servers and clients can commonly be interacted with via an associated API. Some APIs may have associated quotas or quota limits that specify a maximum number of requests to the API that an entity can make within a specified time period.

### BRIEF DESCRIPTION OF THE DRAWINGS

Reference will now be made, by way of example, to the accompanying drawings, which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is an example email synchronization system for synchronizing a first email account and a second email account and handling related search queries.

FIG. 5 is a sequence diagram illustrating an example sequence of operations within the email synchronization system performed by a user, application server, first email client, and second email client.

FIG. 6 is a flow diagram illustrating an example method of responding to a search query pertaining to a first email account.

FIG. 7 is a flow diagram illustrating an example method 700 of synchronizing email accounts including queueing operations that would exceed an API quota limit.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for the management of synchronization between email accounts such that search queries can return relevant responses and applicable API quota limits are accounted for throughout different stages of synchronization. As the volume of email communication has grown, users often find themselves managing multiple email accounts across different providers to separate various aspects of their lives or to maintain accounts from previous engagement (e.g., previous employers or educational institutions). Managing multiple email accounts can be challenging and time-consuming. Users may need to constantly switch between different email clients or web interfaces to access various accounts, leading to inefficiency and the potential for missed important messages. Additionally, maintaining consistent organization and labeling systems across multiple accounts can be difficult, resulting in fragmented information and reduced productivity.

Synchronization between email accounts has been a long-standing desire for many users. Users expect seamless access to all their email accounts on various devices, with real-time updates and consistent user experiences. This demand has created a need for more sophisticated email management solutions that can efficiently handle synchronization while respecting the resource constraints of various devices and the API quota limits established by email providers.

While some email clients offer the ability to aggregate multiple accounts, they often lack robust features for true synchronization, such as maintaining consistent synchronization between stored emails, labels, folders, and settings across accounts. Traditional email synchronization approaches also may not account for a search query being received from a user while the relevant email accounts are not fully synchronized, resulting in incomplete or inaccurate responses to the query because the account being queried has not yet been updated to reflect changes associated with the other account. Furthermore, these solutions may not adequately address the challenges of working with different email providers that have varying APIs, security protocols, and API quota limits.

The present technology overcomes these limitations by providing an email synchronization system that not only performs an initial synchronization between two email accounts but also continuously replicates changes in an email resource associated with one of the accounts in a corresponding resource associated with the other account, resulting in increased consistency of two-way synchronization. Furthermore, when the system determines that a first email account is not yet synchronized with a change in a second email account, search queries received via a client of the first email account are translated into a format compatible with an API of the client for the second email account and the second email client is queried instead of or in addition to the first email client. Querying and returning results from the second email client enables the display of the most recent information received by the email accounts and for more complete responses to the search query to be provided. Computational resources are also conserved by selectively querying the second email account when the two accounts are not synchronized, as additional operations required to query the second email account are not executed when the same search results can be obtained more efficiently by simply querying the first email account.

Additionally, the present technology tracks API usage during email synchronization and querying operations and queues operations for later execution when applicable API quota limits would be reached or exceeded by execution of those operations. Thus, the likelihood of violating API quotas is reduced, helping to avoid consequential delays in synchronization and/or temporary bans from accessing an email client that occur when an applicable API quota limit is violated. By respecting applicable API limits, computational efficiency of the system is further improved as, when operations are executed, those operations are less likely to fail and need to be repeated due to API quota limit violations.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an API request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

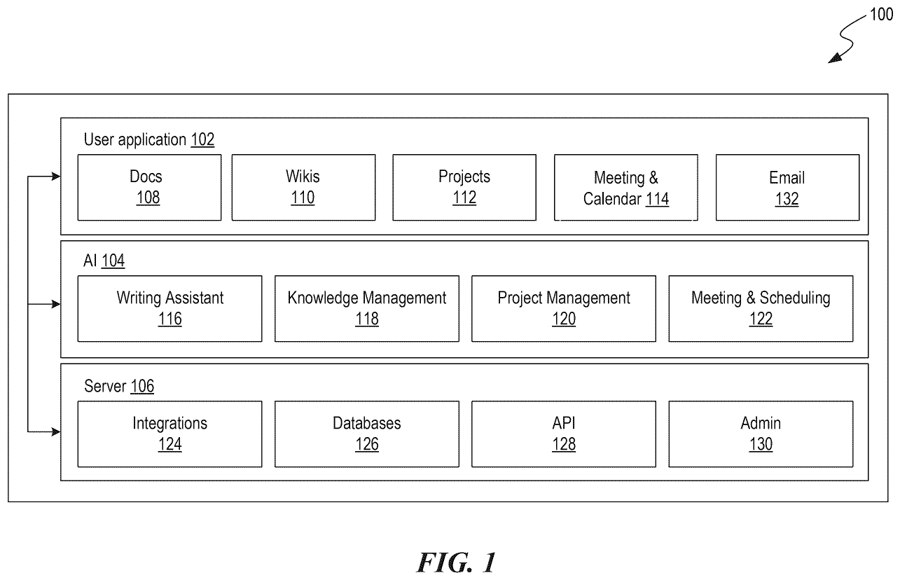

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

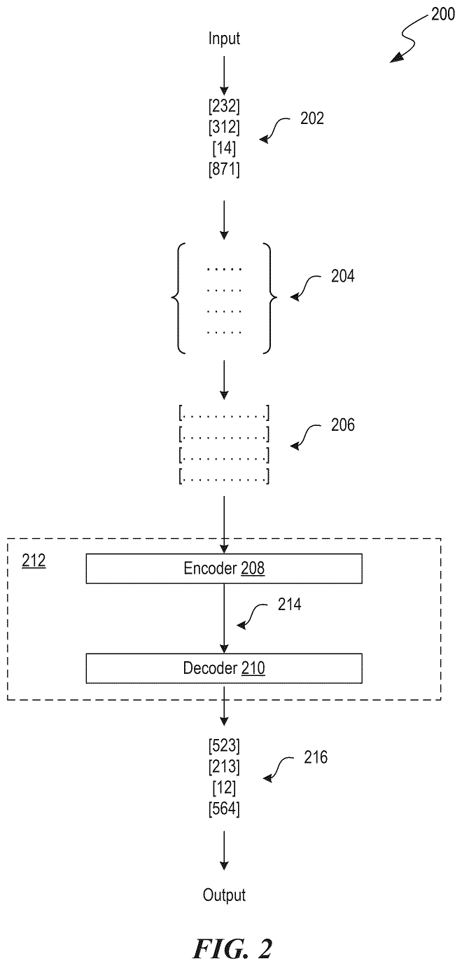

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write”token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

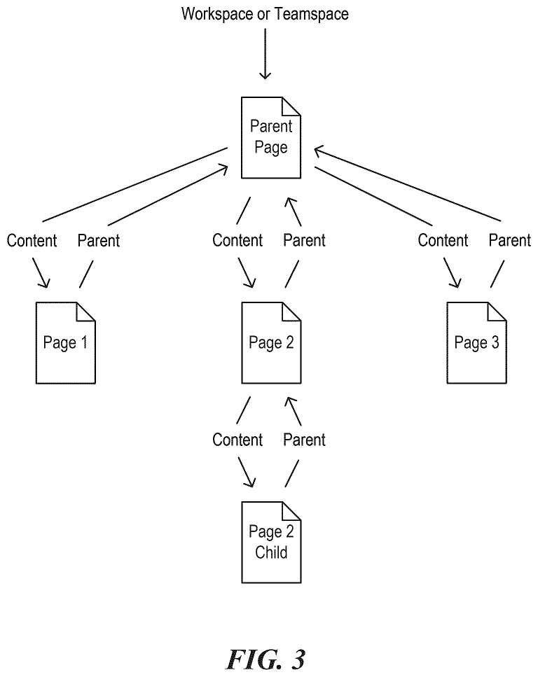

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Email Synchronization System

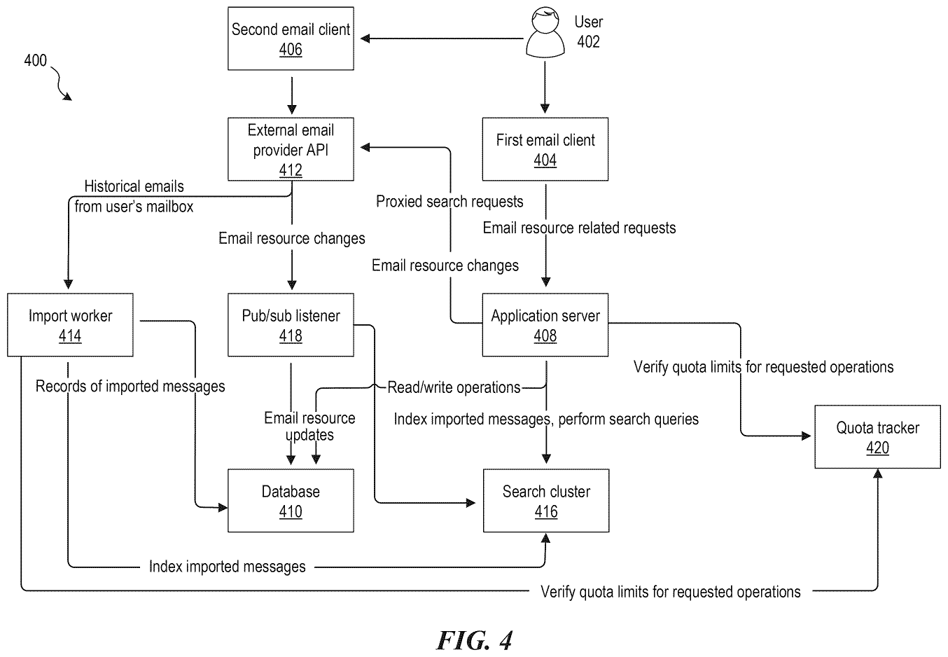

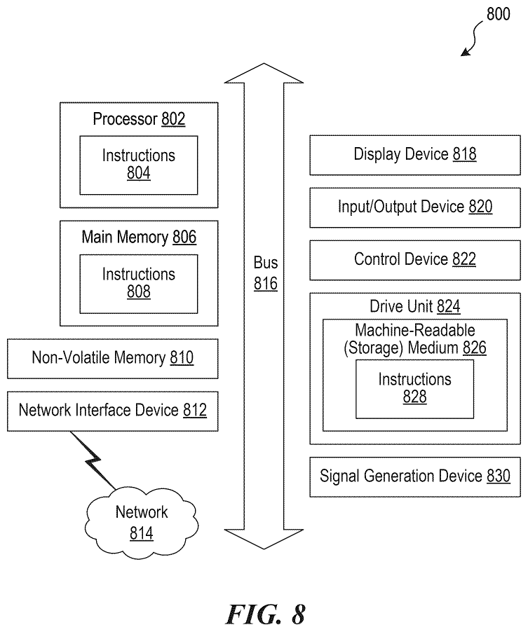

FIG. 4 is an example email synchronization system 400 for synchronizing a first email account and a second email account and handling related search queries. The email synchronization system 400 includes a user 402, first email client 404, second email client 406, application server 408, database 410, external email provider API 412, import worker 414, search cluster 416, pub/sub (“publisher/subscriber”) listener 418, and quota tracker 420. The email synchronization system 400 may be implemented using the computer system illustrated and described in more detail with reference to FIG. 8. Likewise, implementations of the email synchronization system 400 can include different and/or additional components or can be connected in different ways.

The user 402 is an individual or entity controlling at least two different email accounts, with a first email account being accessible via the first email client 404 and a second email account being accessible via the second email client 406. In some embodiments, the first email client 404 is maintained by the entity maintaining the application server 408, while the second email client 406 is maintained by an email provider external to that entity (e.g., Gmail). The user 402 may interact with both email clients 404, 406 to operate the email accounts and add, delete, and/or modify email resources associated with each of the two email accounts. The email synchronization system 400 allows the user 402 to synchronize the email accounts associated with each email client 404, 406 such that changes the user 402 makes to the email resources associated with one account are reflected in the other account.

The application server 408 receives email resource-related requests from the user 402 via the first email client 404 and processes those requests in multiple ways to effect changes in the email resources associated with the first and second email accounts. For example, as depicted in FIG. 4, the application server 408 may perform read/write operations on a database 410 storing email resources associated with the first email account, thereby updating the email resources stored in the database 410 (e.g., by uploading new emails, applying labels to existing emails, deleting emails, etc.). Also as depicted in FIG. 4, the application server 408 may replicate changes made to email resources (e.g., receipt of a new email, addition, modification, or removal of a label associated with an email, and/or modification of a user setting) associated with the first email account for corresponding resources associated with the second email account by calling an external email provider API 412 associated with the second email client 406, thereby synchronizing the two email accounts.

In some embodiments, the application server 408 groups changes to email resources into a plurality of change batches to manage the number of calls made to the external email provider API 412 and reduce the likelihood of exceeding API quota limits associated with the external email provider API 412. For example, the application server 408 may group a plurality of changes into a plurality of change batches, wherein each change batch includes a predetermined number of changes in resources (e.g., determined by an application developer based on the relevant API quota limits) associated with the first email account.

In some embodiments, the application server 408 will verify that executing the plurality of changes in a change batch will not exceed an applicable API quota limit by communicating with a quota tracker 420. The quota tracker 420 is a database and/or a caching system (e.g., a Redis database) that documents the total API quota usage of the email synchronization system 400. For example, the quota tracker 420 may determine an API quota count based on a set of calls that have already been made to the external email provider API 412 within a predetermined period of time preceding the determination (e.g., a period of time corresponding to an applicable API quota limit) and a pending API usage count based on a set of API calls required to replicate the changes in the change batch for corresponding resources associated with the second email account. In some embodiments, the set of calls that have already been made are stored in an API call log, which may record one or more instances of calling the API of the second email client and associate each of those instances with a timestamp corresponding to the time at which the API call was made.

Adding the API quota count to the pending API usage count reveals whether replicating the changes in the change batch would exceed the applicable API quota limit. Accordingly, in some embodiments, replication of the changes in the change batch may be queued for later execution by the quota tracker 420 or operations required for replication may be allowed to fail. In such embodiments, the plurality of changes in a change batch may not be replicated for the second email account until a second API quota count is determined and added to the pending API usage count to determine that the sum of these counts does not match or exceed the applicable API quota limit. As depicted in FIG. 4, the quota tracker 420 may verify quota limits for requested operations being performed by the application server 408 and/or the import worker 414 (described below) before those operations are executed.

In some embodiments, the user 402 provides permission to the application server 408 to synchronize the first and second email accounts, resulting in an initial import operation where historical emails associated with the second email account of the user 402 are added to the database 410 and thereby associated with the first email account. For example, to perform this import operation on behalf of the user 402, the application server 408 may obtain an access token allowing for interaction with the second email account on behalf of the user via the external email provider API 412. Additionally, a refresh token for requesting a new access token to replace the access token currently in use may be obtained by the application server 408.

In some embodiments, the first email account may be new (and therefore have no associated emails) or otherwise not be associated with certain email messages associated with the second account. In such embodiments, after permission is granted by the user 402 to synchronize the accounts and/or access and refresh tokens are obtained, an importation process begins to associate the emails from the second account with the first account. For example, as depicted in FIG. 4, historical emails from the user's 402 mailbox (e.g., the second email account) are imported into the database 410 by the import worker 414. The import worker 414 creates records of the imported emails and uploads them to the database 410 such that they are accessible by the application server 408 and the first and second email accounts are synchronized to be associated with the same set of emails.

In some embodiments, also as depicted in FIG. 4, the import worker further indexes the imported messages in a search cluster 416. The search cluster 416 is a semantic index (e.g., an OpenSearch cluster) in which imported emails are labeled based on their semantic meaning and which can be queried to retrieve emails based on those semantic meanings rather than the literal text of the emails. For example, an email may be indexed within the search cluster 416 by generating a first vector embedding of the email, which is a conversion of the semantic meaning of the email into a numerical vector representing that meaning. Continuing with the same example, the first vector embedding may be stored in a vector database containing a plurality of vector embeddings and compared to a second vector embedding from the vector database representing a second email (e.g., an email previously imported by the application server 408). In some embodiments, comparing the first and second vectors may include calculating a similarity score between the vectors using cosine similarity between the embeddings of the two vectors or another method of calculating similarity between numerical vectors. In such embodiments, the emails represented by the first and second vectors may be grouped together within the search cluster 416 when the calculated similarity score exceeds a predetermined threshold for semantic similarity (e.g., as determined by an application developer).

In some embodiments, a search query is received via the first email client 404 and performed on the search cluster 416 by the application server. For example, the search query may be a request from a user 402 for emails having a specific semantic content or containing a certain category of information (e.g., emails containing current news alerts, bills needing payment, the birthdays of contacts, etc.) to be retrieved. In these and other embodiments, information retrieved by searching in the search cluster 416 may be displayed to the user 402 via the first email client 404 or a separate user interface. Automatically indexing the imported emails in the search cluster 416 allows for computationally efficient retrieval of responses to search queries received via the first email client 404 without the need for manual oversight of the indexing process. Furthermore, indexing in the search cluster 416 conserves the usage of future computational resources by enabling more relevant responses to be provided to search queries, reducing the likelihood that repeated searches are performed.

In some embodiments, a search query may be received by the application server 408 from a user 402 while the first and second email accounts are not synchronized. In such embodiments, the application server 408 will determine that the accounts are not synchronized, meaning that searching within the search cluster 416 alone would provide incomplete results, as the second email account will have associated information that has not yet been imported into the search cluster 416. Therefore, to ensure that relevant results to the search query are not missed, the application server 408 will send proxied search requests to the external email provider API 412 and thereby obtain a response to the search query from the second email client 406. In some embodiments, the proxied search requests are translations of the search query into a format compatible with the external email provider API 412. In these and other embodiments, the response received from the second email client 406 is displayed to the user 402 (e.g., via the first email client 404 or a separate user interface) instead of or in addition to a response to the same search query obtained from the search cluster 416. Selectively searching the second email client 406 when the email accounts have not been synchronized enables the accuracy of responses to search queries to be improved without unnecessarily spending computational resources on searching the second email client 406 when the information contained therein has already been indexed in the search cluster 416 and can be retrieved more efficiently by searching the search cluster 416 instead.

Once the two email accounts have been initially synchronized, the synchronization of the two accounts is maintained via a pub/sub listener 418. The pub/sub listener 418 receives indications from the external email provider API 412 of changes in resources (e.g., receipt of a new email, addition, modification, or removal of a label associated with an email, and/or modification of a user setting) associated with the second email account. For example, the pub/sub listener 418 may subscribe to specific push notification channels (e.g., via a webhook uniform resource locator (URL) registered with the external email provider API 412) maintained by the external email provider that indicate the occurrence of changes in resources. When those changes pertain to the second email account (and therefore also the synchronized first email account), the pub/sub listener 418 may then replicate the same changes in corresponding resources associated with the first email account (e.g., resources stored in the database 410). In some embodiments, when the change in resource pertains to emails indexed in the search cluster 416, the content of the search cluster 416 is updated according to the change, thereby periodically updating the search cluster 416 to contain indexed information received via the second email account.

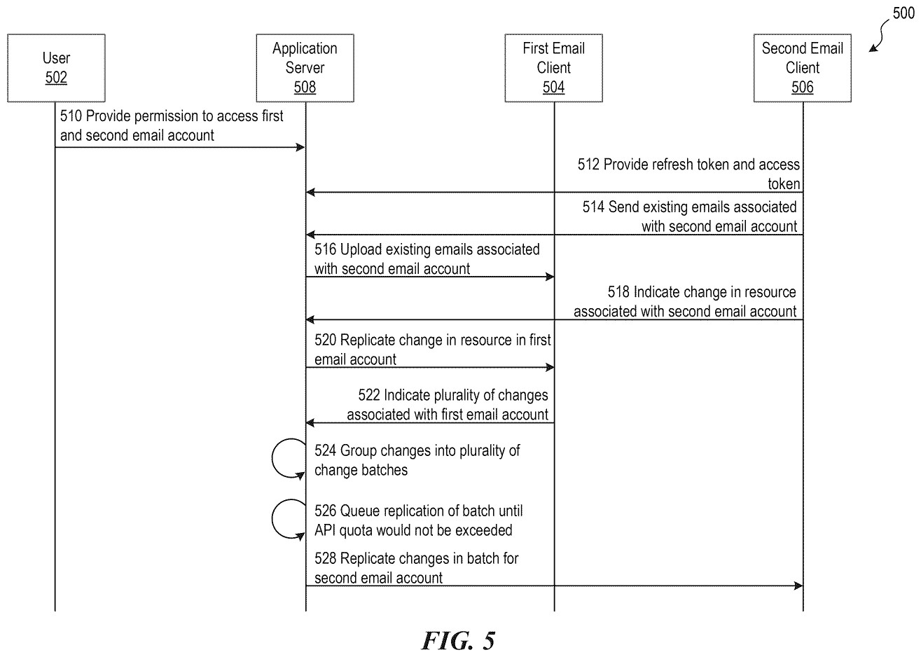

FIG. 5 is a sequence diagram illustrating an example sequence 500 of operations within the email synchronization system 400 performed by a user 502, application server 508, first email client 504, and second email client 506. The example sequence 500 represents a sequence of actions taken to initialize synchronization between two email accounts and maintains that synchronization as changes in the resources associated with one email account or the other occur. In some embodiments, the user 502, application server 508, first email client 504, and second email client 506 performing this sequence 500 are the same as or generally similar to the user 402, application server 408, first email client 404, and second email client 406 described in relation to FIG. 4 above.

In operation 510, a user 502 provides permission to the application server 508 to access a first email account and a second email account, allowing the application server 508 to initialize synchronization of the two accounts. In some embodiments, the first email account is a new email account containing no emails before synchronization or is an existing account containing emails different from the emails contained in the second email account. In these and other embodiments, the user may provide the permission via a user interface (e.g., included in the first email client 504).

In operation 512, the second email client 506 provides a refresh token and access token to the application server 508. The access token is used by the application server 508 to verify that the application server 508 is authorized to communicate with the second email client 506 on behalf of the user (e.g., via an external email provider API 412 as described in relation to FIG. 4 above). The refresh token is used by the application server 508 to request a new access token when the initial access token (or a subsequent access token) expires or otherwise requires replacement.

In operation 514, the second email client 506 sends existing emails associated with the second email account to the application server 508. In some embodiments, these emails are not received by the application server 508 directly but are instead recorded to a database accessible by the application server 508 by an import worker, which may simultaneously index those emails in a search cluster. In such embodiments, the database, import worker, and search cluster may be the same or generally similar to the database 410, import worker 414, and search cluster 416 as described in relation to FIG. 4 above. In these and other embodiments, the second email client 506 may additionally send other email-related resources to the application server 508, such as labels associated with certain emails and/or user settings applied to the second email account.

In operation 516, the existing emails associated with the second email account are uploaded by the application server 508 to the first email client 504 such that they become associated with the first email account. By uploading these emails to the first email client 504, the application server 508 synchronizes the first and second email accounts, enabling the user 502 to access the same set of emails using either the first email client 504 or the second email client 506. In embodiments where the second email client 506 additionally sends other email-related resources to the application server 508, the application server 508 may additionally synchronize these resources between the two accounts by replicating these resources within the first email client 504 (e.g., changing user settings associated with the first email account to match those associated with the second email account).

However, the synchronization of the two email accounts may be disrupted when a new email is sent to the second email account or another associated resource is changed. Thus, in operation 518, a change in a resource associated with the second email account is indicated to the application server 508 by the second email client 506. As a response, in operation 520, the application server 508 replicates the indicated change in resource in a corresponding resource associated with the first email account, thereby synchronizing the two email accounts once again. For example, the application server 508 may accomplish this replication by calling an external email provider API 412 associated with the second email client 406, as described in relation to FIG. 4 above.

The two email accounts may also become desynchronized when one or more changes in resources associated with the first email account occur. Thus, in operation 522, a plurality of changes in resources associated with the first email account is indicated to the application server 508 by the first email client 504. In some embodiments, in order to replicate these changes in corresponding resources associated with the second email account, an API associated with the second email client may be called repeatedly, raising the risk of exceeding applicable API quota limits. Exceeding these limits may cause delays in synchronization and/or temporary bans from accessing the second email client 506. Thus, to improve the accuracy and efficiency of synchronization, the application server 508 does not execute replication of the changes immediately and instead executes several operations for managing the API quota usage of the application server 508.

The first of these operations is operation 524, in which the plurality of changes are grouped into a plurality of change batches. Each change batch includes a predetermined number of changes in resources (e.g., determined by an application developer based on the relevant API quota limits) from the plurality of changes. Then, in operation 526, the replication of the changes in a change batch is queued until replication of the entire batch would not exceed the applicable API quota limit, thereby reducing the likelihood that the application server 508 will execute too many API calls at once and exceed the API quota limit. In some embodiments, replication of the change batch is queued until the application server 508 receives verification from a quota tracker that the API quota limit will not be exceeded. For example, the quota tracker may be the same or generally similar to the quota tracker 420 as described in relation to FIG. 4 above and may likewise determine whether replicating the changes in the change batch would exceed the applicable API quota limit using an API quota count and pending API usage count.

In operation 528, once the application server 508 determines that replication of the change batch would not exceed the API quota limit, the application server 508 replicates the changes in the change batch for corresponding resources associated with the second email account, thereby once again synchronizing the first email account and second email account. In some embodiments, this replication occurs by interacting with the second email client 506 via an associated API.

### Example Method of Email Search Query Response

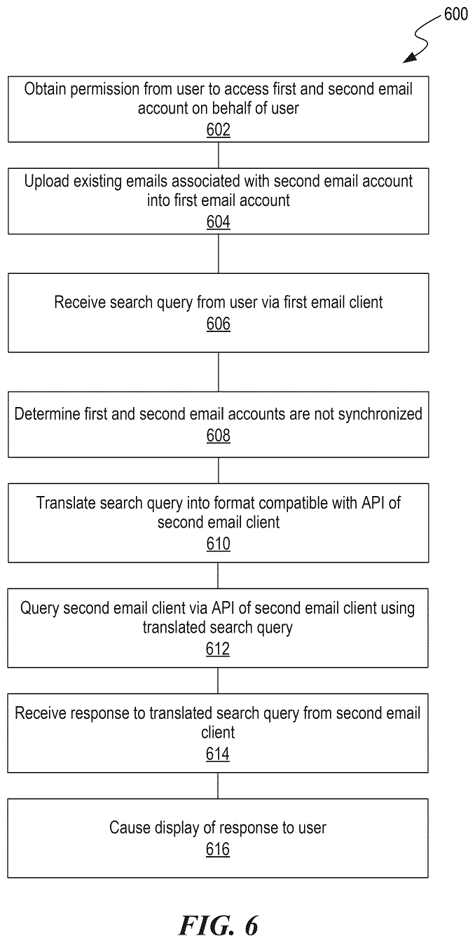

FIG. 6 is a flow diagram illustrating an example method 600 of responding to a search query pertaining to a first email account. In operation 602, permission is obtained from a user to access a first email account and second email account on behalf of the user. In some embodiments, the first and second email accounts are both controlled by the user but maintained by different email-providing entities, as described in relation to FIG. 4 above. Also as described in relation to FIG. 4, permission to access the second email account may be verified using an access token, which may in turn be replaced periodically using a refresh token.

In operation 604, existing emails associated with the second email account are uploaded into the first email account such that they additionally become associated with the first email account. In some embodiments, the emails are uploaded into the first email account by an application server managed by the entity managing the first email account. In such embodiments, as described in relation to FIG. 4 above, the emails may be received by the application server via an import worker 414, which imports the emails from the second email account and uploads them to a database 410 and/or a search cluster 416.

In operation 606, a search query is received from the user via a first email client associated with the first email account. The search query is an input from the user requesting information that may be contained in the emails associated with the first and/or second email accounts. For example, the search query may be a request from a user for emails having a specific semantic content or containing a certain category of information (e.g., emails containing current news alerts, bills needing payment, the birthdays of contacts, etc.) to be retrieved.

In operation 608, a determination that the first and second email accounts are not synchronized is made. The two accounts are not synchronized when, for example, the upload of existing emails described in operation 604 has not yet been completed, when operation 604 has been completed but a new email has been received by the second email account and not yet been replicated in the first email account, or when the email resources associated with the two accounts otherwise do not match. When the two accounts are not synchronized, more and/or different information may be associated with the second email account than the first email account. Therefore, searching the emails associated with the second email account may provide a more complete response to the search query than searching the emails associated with the first email account, even though the search query was received via the first email client.

Accordingly, in operation 610, the search query is translated into a format compatible with an API of the second email client and, in operation 612, the second email client is queried via the API using the translated search query. For example, the second email client may be a Gmail client accessible via a Gmail API. The Gmail API, however, may only accept queries of a certain format, which may not be the same format as the query received by the first email client. Thus, the search query may be translated to retain the semantic meaning of the search query (e.g., still comprise a request for the same information) and also be readable by the Gmail API, after which the Gmail client is queried using the translated search query. In some embodiments, the first email client and/or a database associated with the first email account are queried in addition to the second email client to increase the probability of retrieving information relevant to the query.

In operation 614, a response to the translated search query is received from the second email client. For example, the response may include one or more emails containing semantic content requested by the search query and may be received via an API of the second email client. In operation 616, the received response is caused to be displayed to the user. For example, the response may be displayed via the first email client or a separate user interface at the direction of an application server having received the response.

### Example Method of Email Resource Change Synchronization

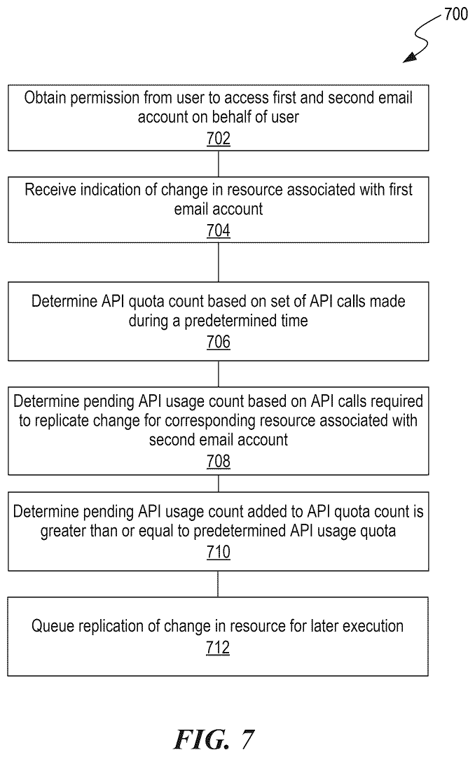

FIG. 7 is a flow diagram illustrating an example method 700 of synchronizing email accounts including queueing operations that would exceed an API quota limit. In operation 702, permission is obtained from a user to access a first email account and second email account on behalf of the user. In some embodiments, the first and second email accounts are both controlled by the user but maintained by different email-providing entities, as described in relation to FIG. 4 above. Also as described in relation to FIG. 4, permission to access the second email account may be verified using an access token, which may in turn be replaced periodically using a refresh token.

In operation 704, an indication of a change in a resource associated with the first email account is received. For example, the resource may be an email, a label for an email, a user setting, or another email-related resource, while the change may be an addition, deletion, or modification of any of those resources.

In operation 706, a determination is made of an API quota count based on a set of API calls made during a predetermined period of time. For example, the API quota count may be based on the API calls recorded in an API call log and/or quota tracker 420, both as described in relation to FIG. 4 above. In operation 708, an additional determination is made of a pending API usage count based on a set of API calls required to replicate the change in resource for a corresponding resource associated with the second email account. Depending on the API being called, different operations may contribute differently toward reaching a quota limit associated with the API. For example, the Google Cloud API allows 240 API calls per minute for read-only calls but only 120 API calls per minute for write calls. Thus, in some embodiments, the API quota count and/or pending API usage count will be tailored to the type of operation being performed and/or be determined based on referencing a database specifying a number of API quota limits required to execute each of the calls in the applicable set of API calls.

In operation 710, a determination is made that the pending API usage count added to the API quota count is greater than or equal to a predetermined API usage quota. In some embodiments, the predetermined API usage quota is the same or generally similar to the predetermined API usage quota described in relation to FIG. 4 above. Thus, adding the API quota count to the pending API usage count reveals whether replicating the change in resource would exceed an applicable API quota limit represented by the predetermined API usage quota.

In operation 712, replication of the change in resource is queued for later execution. Queueing the replication enables the likelihood of exceeding applicable API quota limits to be reduced, thereby reducing the likelihood of delays in synchronization and/or temporary bans from accessing the second email client resulting from exceeding these limits. Queueing replication of the change in resource for later execution therefore improves computational efficiency, as the operations required for replication can be delayed until the operations will succeed without error on first execution, reducing the likelihood of repeated or failed operations.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising
instructions recorded thereon, wherein the instructions, when executed by at least one data processor of a system, cause the system to:
obtain permission from a user to access a first email account and a second email account on behalf of the user,
wherein the first email account is different from the second email account,
wherein the first email account is accessible via a first email client, and
wherein the second email account is accessible via a second email client different from the first email client;
obtain a refresh token and an access token from the second email client,
wherein the refresh token and access token are used to access an application programming interface (API) of the second email client on behalf of the user;
upload existing emails associated with the second email account into the first email account;
receive an indication of a change in a resource associated with the second email account,
wherein the indication is received via a webhook uniform resource locator (URL) registered with the API of the second email client;
replicate the change in the resource associated with the second email account for a corresponding resource associated with the first email account,
thereby synchronizing the first email account with the second email account;
receive an indication of a plurality of changes in resources associated with the first email account;
group the plurality of changes into a plurality of change batches,
wherein each change batch includes a predetermined number of changes in resources associated with the first email account;
determine an API quota count,
wherein the API quota count is based on a set of calls of an API associated with the second email client made during a predetermined period of time prior to said determining;
determine a pending API usage count,
wherein the pending API usage count is based on a set of calls of the API associated with the second email client required to replicate the changes in a change batch for corresponding resources associated with the second email account;
determine that the pending API usage count added to the API quota count is greater than or equal to a predetermined API usage quota;
queue replication of the changes in the change batch for corresponding resources associated with the second email account for later execution;
determine a second API quota count,
wherein the second API quota count is based on a set of calls of the API associated with the second email client made during the predetermined period of time prior to said determining;
determine that the pending API usage count added to the second API quota count is less than the predetermined API usage quota; and
replicate the changes in the change batch for corresponding resources associated with the second email account by calling the API associated with the second email client,
thereby synchronizing the second email account with the first email account.

2. The non-transitory, computer-readable storage medium of claim 1, further comprising instructions to:
receive a search query from the user via the first email client;
determine that the first email account and second email account are not synchronized;
translate the search query into a format compatible with the API of the second email client;
query the second email client via the API of the second email client using the translated search query;
receive a response to the translated search query from the second email client; and
cause a display of the response to the user.

3. The non-transitory, computer-readable storage medium of claim 1, further comprising instructions to:
record an API call in an API call log,
wherein the API call is an instance of calling the API of the second email client associated with a timestamp;
determine that the API call log contains API calls requiring an amount of API usage greater than or equal to the predetermined API usage quota; and
queue an operation requiring an additional call of the API of the second email client for later execution or cause the operation to fail.

4. The non-transitory, computer-readable storage medium of claim 1, further comprising instructions to:
index the uploaded existing emails in a search cluster;
periodically update the search cluster to reflect changes made to resources associated with the second email account;
receive a search query from the user via the first email client;
search the search cluster to retrieve information relevant to the search query; and
cause display of the retrieved information to the user.

5. The non-transitory, computer-readable storage medium of claim 1, wherein:
the change in the resource associated with the second email account and the changes in the plurality of changes in resources associated with the first email account include at least one of:
a receipt of a new email;
an addition, modification, or removal of a label associated with an email; or
a modification of a user setting.

6. A system comprising:
at least one hardware processor; and
at least one non-transitory memory storing instructions, which, when executed by the at least one hardware processor, cause the system to:
obtain permission from a user to access a first email account and a second email account on behalf of the user,
wherein the first email account is different from the second email account,
wherein the first email account is accessible via a first email client, and
wherein the second email account is accessible via a second email client different from the first email client;
upload existing emails associated with the second email account into the first email account;
receive a search query from the user via the first email client;
determine that the first email account and second email account are not synchronized;
translate the search query into a format compatible with an API of the second email client;
query the second email client via the API of the second email client using the translated search query;
receive a response to the translated search query from the second email client; and
cause a display of the response to the user.

7. The system of claim 6, further comprising instructions to:
record an API call in an API call log;
wherein the API call is an instance of calling the API of the second email client associated with a timestamp;
determine that the API call log contains API calls requiring an amount of API usage greater than or equal to a predetermined API usage quota; and
queue an operation requiring an additional call of the API of the second email client for later execution or cause the operation to fail.

8. The system of claim 6, further comprising instructions to:
index the uploaded existing emails in a search cluster;
periodically update the search cluster to reflect changes made to resources associated with the second email account;
receive a search query from the user via the first email client;
search the search cluster to retrieve information relevant to the search query; and
present the retrieved information to the user via the first email client.

9. The system of claim 6, further comprising instructions to:
receive an indication of a change in a resource associated with the second email account; and
replicate the change in the resource associated with the second email account for a corresponding resource associated with the first email account, thereby synchronizing the first email account with the second email account.

10. The system of claim 6, further comprising instructions to:
obtain a refresh token and an access token from the second email client,
wherein the refresh token and access token are used to access an API of the second email client on behalf of the user.

11. The system of claim 6, wherein:
said receiving a search query, determining that the first email account and second email account are not synchronized, translating the search query, and querying the second email client occur during said uploading of existing emails associated with the second email account into the first email account.

12. A method comprising:
obtaining permission from a user to access a first email account and a second email account on behalf of the user,
wherein the first email account is different from the second email account,
wherein the first email account is accessible via a first email client, and
wherein the second email account is accessible via a second email client different from the first email client;
receiving an indication of a change in a resource associated with the first email account;
determining an API quota count,
wherein the API quota count is based on a set of calls of an API associated with the second email client made during a predetermined period of time prior to said determining;
determining a pending API usage count,
wherein the pending API usage count is based on a set of calls of the API associated with the second email client required to replicate the change in a resource associated with the first email account for corresponding resources associated with the second email account;
determining that the pending API usage count added to the API quota count is greater than or equal to a predetermined API usage quota; and
queueing replication of the change for a corresponding resource associated with the second email account for later execution.

13. The method of claim 12, further comprising:
determining a second API quota count,
wherein the second API quota count is based on a set of calls of the API associated with the second email client made during the predetermined period of time prior to said determining;
determining that the pending API usage count added to the second API quota count is less than the predetermined API usage quota; and
replicating the change for a corresponding resource associated with the second email account by calling the API associated with the second email client, thereby synchronizing the second email account with the first email account.

14. The method of claim 12, further comprising:
receiving an indication of a plurality of changes in resources associated with the first email account;
grouping the plurality of changes into a plurality of change batches,
wherein each change batch includes a predetermined number of changes in resources associated with the first email account; and
determining the pending API usage count based on a set of calls of the API associated with the second email client required to replicate the changes in a change batch for corresponding resources associated with the second email account.

15. The method of claim 12, further comprising:
receiving an indication of a change in a resource associated with the second email account; and
replicating the change in the resource associated with the second email account for a corresponding resource associated with the first email account, thereby synchronizing the first email account with the second email account.

16. The method of claim 12, further comprising:
receiving a search query from the user via the first email client;
determining that the first email account and second email account are not synchronized;
translating the search query into a format compatible with the API of the second email client;
querying the second email client via the API of the second email client using the translated search query;
receiving a response to the translated search query from the second email client; and
causing a display of the response to the user.

17. The method of claim 16, further comprising:
uploading existing emails associated with the second email account into the first email account,
wherein said receiving a search query, determining that the first email account and second email account are not synchronized, translating the search query, and querying the second email client occur during said uploading of existing emails.

18. The method of claim 12, further comprising:
uploading existing emails associated with the second email account into the first email account;
indexing the uploaded existing emails in a search cluster;
periodically updating the search cluster to reflect changes made to resources associated with the second email account;
receiving a search query from the user via the first email client;
searching the search cluster to retrieve information relevant to the search query; and
presenting the retrieved information to the user via the first email client.

19. The method of claim 12, further comprising:
recording an API call in an API call log,
wherein the API call is an instance of calling the API of the second email client associated with a timestamp;
determining that the API call log contains API calls requiring an amount of API usage greater than or equal to the predetermined API usage quota; and
queueing an operation requiring an additional call of the API of the second email client for later execution or causing the operation to fail.

20. The method of claim 12, wherein:
the change in the resource associated with the first email account is at least one of:
a receipt of a new email;
an addition, modification, or removal of a label associated with an email; or
a modification of a user setting.
